(19) United States
(12) Patent Application Publication
(10) Pub. No.: US 2009/0053934 A1
(43) Pub. Date: Feb. 26, 2009

(54) TERMINATION BLOCK WITH FUNCTIONAL MODULE

(75) Inventors: Guy Metral, Cluses (FR); Xavier Fasce, Verchaix (FR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/179,008

(22) Filed: Jul. 24, 2008

Related U.S. Application Data
(60) Provisional application No. 60/957,866, filed on Aug. 24, 2007.

(51) Int. Cl. H01R 13/66

(52) U.S. Cl. 439/620.01

(57) ABSTRACT

A termination block comprises a housing with contact elements for connecting electrical conductors therewith and a cap that is pivotally attached to the housing of the termination block and can be swivelled from an open position into a closed position, wherein the cap comprises a functional module.

### CROSS-REFERENCE TO RELATED APPLICATION

This application claims the benefit of U.S. Provisional Patent Application No. 60/957866, filed Aug. 24, 2007, the disclosure of which is incorporated by reference herein in its entirety.

### FIELD OF THE INVENTION

The invention relates to a termination block with contact elements for connecting electrical conductors therewith comprising a functional module.

### DESCRIPTION OF THE RELATED PRIOR ART

In the field of telecommunications, numerous customers are connected with the switch of a telecommunication company via telecommunications lines. The customers can also be called subscribers. The switch is also called an exchange of PBX (central office exchange operated by the telecommunications company). Between the subscriber and the switch, sections of the telecommunication lines are connected with telecommunication modules or termination blocks. The telecommunication modules or termination blocks establish an electrical connection between an electrical conductor or wire, which is attached to the telecommunications module at a first side and another wire, which is attached to the telecommunication module at a second side. The wires of one side can also be called outgoing wires. Plural telecommunication modules can be put together at a distribution point, such as a main distribution frame, an intermediate distribution frame, an outside cabinet or a distribution point located, for example, in an office building or on a particular floor of an office building. To allow flexible wiring, some telecommunication lines are connected with first telecommunication modules in a manner to constitute a permanent connection. Flexibility is realized by so called jumpers or cross connects, which flexibly connect contacts of the first telecommunication module with contacts of a second telecommunication module.

These jumpers can be changed when a person moves within an office building or with his private home to provide a different telephone (i.e. a different telephone line) with a certain telephone number, which the relocated person intends to keep. In the telecommunications module or termination block, disconnection points can be located in the electrical connection between the two sides. At such disconnection point, disconnection plugs can be inserted, in order to disconnect the line. Furthermore, protection plugs and magazines are known. These are connected to the modules or blocks and protect any equipment connected to the wire from overcurrent and/or overvoltage. Finally, test plugs can be inserted at a disconnection point in order to test or monitor a line.

EP 1 750 337 A1 describes a line protector for a telecommunication circuit, in which two overvoltage protectors are arranged in a plug. Through contacts of the protector, the overvoltage protectors are connected to one wire of four telecommunication lines. With one plug two wires of telecommunication lines, which each have a wire pair, can be protected.

EP 0 992 096 B1 discloses an overvoltage protection magazine for a termination block with a housing, several contacts and one earth contact. Several overvoltage arresters are arranged in the housing of the magazine. The overvoltage protection magazine is designed in a way that it fits to one row in a termination block and protects every wire or every pair of wires in that row.

There is a need for a protection device for telecommunication modules, especially termination blocks, that is easy to manufacture and easy to handle and that is at the same time providing a dependable protection for any equipment connected to wires of the termination block.

### SUMMARY OF THE INVENTION

The invention provides a termination block or termination module comprising a housing with contact elements for connecting electrical conductors therewith. The termination block further comprises a cap that is pivotally attached to the housing of the termination block and can be swivelled from an open position into a closed position. According to the invention the termination block comprises a functional module that is located in the cap.

The housing of the termination block can be made of plastic or any other suitable material and can be constituted by one or more components. It has to be non-conductive in the area of the contact elements. Such housings can be manufactured in a very cost saving manner, e.g. by injection moulding. The housing serves to accommodate the contact elements, to which telecommunication lines, e.g. electrical conductors, are connectable. The housing can have specific structures for positioning the contacts therein. Moreover, the housing can comprise one or more cavities or receiving spaces, which are adapted to accommodate the contact elements or other objects, such as for example electronic components. Finally, the housing can comprise suitable structures, typically at the outside thereof, to enable the termination block to be mounted to a rack or other suitable carrier in the field of telecommunications.

The termination block comprises contact elements for connecting electrical conductors therewith. As will be apparent to those skilled in the art, a telecommunications line will normally be constituted by a pair of electrical conductors. Similarly, the telecommunications contacts are also arranged in pairs. Moreover, termination blocks are known in which the telecommunications contacts or contact elements are arranged in two or more parallel rows, with pairs of contacts being located opposite to each other. Thus the termination block can have the shape of a strip. Any other shape of the termination block is possible as well.

The termination block according to the invention further comprises a cap that is pivotally attached to the housing. The cap can be made out of plastic as well or another suitable material. It may further be constituted by one or more components. Making the cap out of plastic has the advantage that it can be easily manufactured by injection moulding. The cap may be attached to the housing by any means that is known to those skilled in the art to establish a swivelling connection between the cap and the housing, such as for example a swivel axis, a living hinge etc. The cap may be assigned to one contact, to a contact pair, to a row of contacts and/or to several rows of contacts. The shape and the size of the cap vary depending on the number of contacts to which it is assigned.

The termination block according to the invention further comprises a functional module located in the cap. Functional modules are modules, which contain any component which provide protection against overvoltage and/or overcurrent, as well as testing and monitoring modules, which contain suitable electronic components and circuits in order to test and/or monitor a telecommunication line. A functional module can also be any electronic control or switch device or other outside telecommunication modules such as for example a splitter. Furthermore, additional functional modules in the above sense are known to those skilled in the art. Integrating the functional module into the cap that is pivotally attached to the housing of the termination block has the advantage that such an assembly is very easy to handle since the functional module is attached to the termination block and does not have to be separately attached to the termination block. In other words, the functional module is integrated into the termination block.

According to one embodiment of the invention, the contact elements may comprise insulation displacement contact (IDC) elements with slots in which the electrical conductor may be urged for making an electrical connection. An IDC element displaces or cuts through the insulation from a portion of the electrical conductor when the electrical conductor is inserted into the slot of the IDC element. Once the electrical conductor is inserted within the slot and the insulation displaced, electrical contact is made between the conductive surface of the IDC element and the conductive core of the electrical conductor. Other solutions of connecting an electrical conductor to a contact element are possible as well such as for example wire wrapping, etc.

According to another embodiment of the invention, the cap may comprise means for urging the electrical conductor into the IDC element. A certain amount of force is needed to urge the electrical conductor into the slot of the IDC element. Therefore, the cap may comprise a specially designed area that is capable of guiding, forcing and/or urging the conductor into the IDC element. For example, the guiding area may comprise a wire hugger and/or a wire stuffer, whereby the wire stuffer would be aligned with the IDC element. When the cap is swivelled into its closed position, the underside of the wire stuffer engages the electrical conductor. The wire hugger and the wire stuffer engage with the upper exposed surface of the electrical conductor. Upon complete closure of the cap, the wire stuffer follows and pushes the electrical conductor into the IDC element while the wire hugger guides and aligns the electrical conductor with the IDC element. Other designs of the underside of the cap are also possible. The cap may also comprise at least one aperture or port for providing test access to the IDC block and/or for filling a sealant component (e.g. a gel) into the IDC block to provide environmental protection. This embodiment is advantageous because the cap of the termination block supports two functions—termination of electrical conductors and housing of functional modules.

The functional module of the invention may be an overvoltage protection device. An overvoltage protection device is a protection device with a gas discharge tube and contacts for connecting the gas discharge tube to contacts of the telecommunication line to be protected by the overvoltage protection device. Gas discharge tubes are usually placed in front of and in parallel with the sensible equipment acting as a high impedance component while not influencing the signal in normal operation. In the event of an overvoltage surge, such as for example a lightning strike, the gas discharge tube switches to a low impedance state, and diverts the energy away from sensitive equipment. The functional module may also be an overcurrent protection device, a testing and/or monitoring module, which contains suitable electronic components and circuits in order to test and/or monitor a telecommunication line, or a switch and/or control device. The cap may also be used to accommodate more than one functional module. It may accommodate any combination of the above mentioned functional modules.

The overvoltage protection device may be a two or a three electrode overvoltage protection device. The two electrode overvoltage protection device provides two electrodes that are connected with the contact elements of the telecommunication being protected by the overvoltage protection device of the termination block. The three electrode overvoltage protection device provides three electrodes. Two of the three electrodes are connected with contact elements of the telecommunication line that is being protected by the overvoltage protection device of the termination block. The third electrode is connected to another contact of a grounding element to divert energy away from a telecommunication line.

In another aspect, the present invention provides a termination block with a grounding element. The grounding element may be a grounding bar made of metal or a metallised material, for example, metallised plastic or any other insulating material having a surface, which is at least partially coated with a conductive material, in order to provide the required electrical conductivity. The grounding element can also be provided separate from the termination block and/or separate from a carrier so as to add a ground connection to a termination block, which is already mounted to a carrier without a grounding connection. Such a retrofit is, for example, beneficial when new functions are added to a previously installed telecommunications module that requires a connection to ground for its new functions. Thus, the grounding element can be prepared so as to be retrofittable to a telecommunications module and/or to a carrier. As an alternative, the termination block and/or the carrier can be provided with the grounding element, when the termination block is mounted to the carrier for the first time, in order to advantageously provide an assembly having the ground connection from the beginning. The termination block may also comprise several grounding elements, e.g. one grounding element or grounding bar for each row of contacts.

In a further aspect, the present invention provides a termination block with a cap and a grounding contact electrically connecting the overvoltage protection device with the grounding element of the termination block. The grounding contact is at least partially integrated in the cap so that—when the cap is in its closed position—the grounding contact electrically connects the overvoltage protection device with the grounding element of the termination block. The grounding contact may be made out of metal, metallised material or any other suitable conductive material. It may be a piece of stamped sheet metal with a shape that fits into the cap, or it may be a wire that is integrated in the cap. The grounding contact may comprise one leg for making an electrical connection to the overvoltage protection device and another leg for making an electrical connection to the grounding element. The grounding contact may be used as a fixed element for the gas discharge tube.

In yet another aspect, the present invention provides a termination block with contact elements and a cap. Protection contacts are at least partially integrated in the cap to electrically connect the overvoltage protection device with the contact elements of the termination block. The protection contacts may be made out of metal, metallised material or any other suitable conductive material. It may be a piece of stamped sheet metal with a shape that fits into the cap, or it may be a wire that is integrated in the cap. The protection contact may comprise one leg for making an electrical connection with the contact elements of the termination block. It may comprise another leg for making an electrical connection with the contact elements of the termination block when the cap is in its closed position. The termination block according to the invention may comprise two protection contacts one on each side of the gas discharge tube of the overvoltage protection device for providing electrical contact between the overvoltage protection device and two contact elements for a pair of contact elements for one telecommunication line. The protection contacts may also be used as fixing elements for the gas discharge tube.

### BRIEF DESCRIPTION OF THE DRAWINGS

The invention will now be described in more detail with reference to the following Figures exemplifying particular embodiments of the invention:

FIG. 1 is a schematic front view of a number of termination blocks;

FIG. 2 is a schematic and partially cut side view of an assembly including a termination block of FIG. 1;

FIG. 3 is a schematic and partially cut second side view of the assembly of FIG. 2;

FIG. 4 is a three dimensional view of a contact element with an overvoltage protection device;

FIG. 5 is a cross section and partially cut section side view of a termination block with a cap in an open position; and

FIG. 6 is a cross section and partially cut section side view of a termination block according to FIG. 5 with a cap in a closed position.

### DETAILED DESCRIPTION OF THE DRAWINGS

Herein below various embodiments of the present invention are described and shown in the drawings wherein like elements are provided with the same reference numbers.

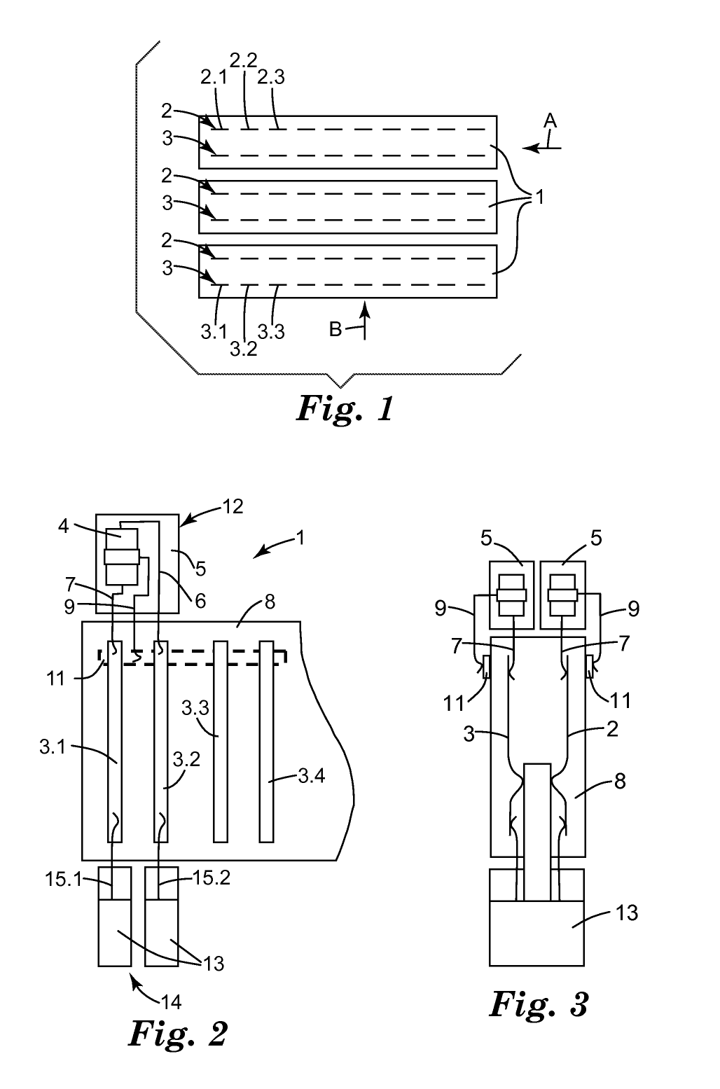

FIG. 1 shows a schematic front view of three telecommunication modules or termination blocks 1 which each have, in the embodiment shown, a strip-like appearance. Parallel to the extension of the “strip”, i.e. from left to right, rows 2 and 3 of telecommunication contacts or contact elements 2.1, 2.2, 2.3 . . . and 3.1, 3.2, 3.3 . . . extend.

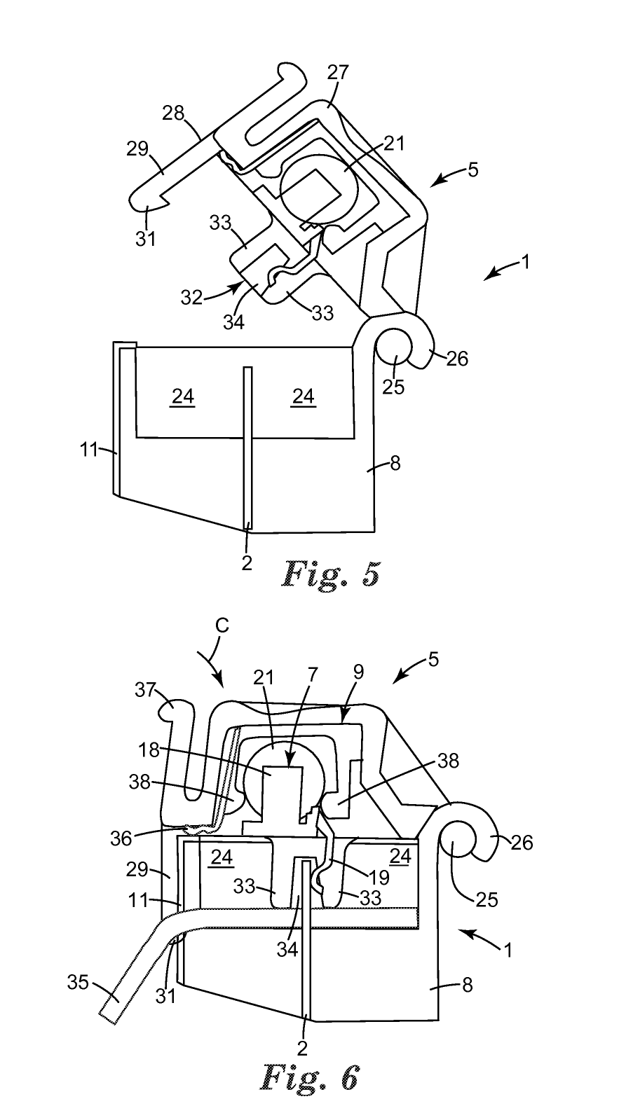

As shown in FIG. 2, which is a side view from direction B in FIG. 1, an overvoltage protection device 4, is integrated into a cap 5 that is attached to the termination block 1. How the cap 5 is attached to the termination block 1 will be described in further detail with respect to FIGS. 5 and 6. In particular, in the embodiment shown, the overvoltage protection device 4 is a three electrode overvoltage protection module. Two protection contacts 6 and 7 extend from two electrodes of the overvoltage protection device 4 into the housing 8 of the termination block 1 so as to contact the contact elements 3.1 and 3.2. Thus, protection from the overvoltage protection device 4 is applied to both contact elements 3.1 and 3.2 and both wires of a wire pair that are connected to the contact elements 3.1 and 3.2. Moreover, in the embodiment shown, the grounding contact 9 connects the third electrode of the overvoltage protection device 4 with a grounding element or a ground bar 11 of the termination block 1, which extends substantially along the entire length of the termination block 1 and along all contact elements 3. FIG. 2 shows that the overvoltage protection device 4 can be fitted from a front side 12 of the termination block 1, and another electronic module 13, such as for example a splitter, can be fitted from a rear side 14 of the termination block 1. In order to establish the necessary electrical connections to “split” or “combine” a signal, splitter contacts 15.1 and 15.2 are connected with the contact elements 3.1 and 3.2.

FIG. 3 shows the assembly of FIG. 2 from direction A in FIG. 1. It is shown in FIG. 3 that the ground bar 11 extends along two outsides of the housing 8 of the termination block 1. It can also be seen that each row of contacts 2 and 3 has its own cap 5 and each cap 5 has its own overvoltage protection device 4. From the perspective shown in FIG. 3 can be seen the grounding contact 9 contacting the ground bar 11 and one of the protection contacts 6 or 7 contacting each one contact element 2.1 and 3.1 of the rows 2 and 3 of contact elements.

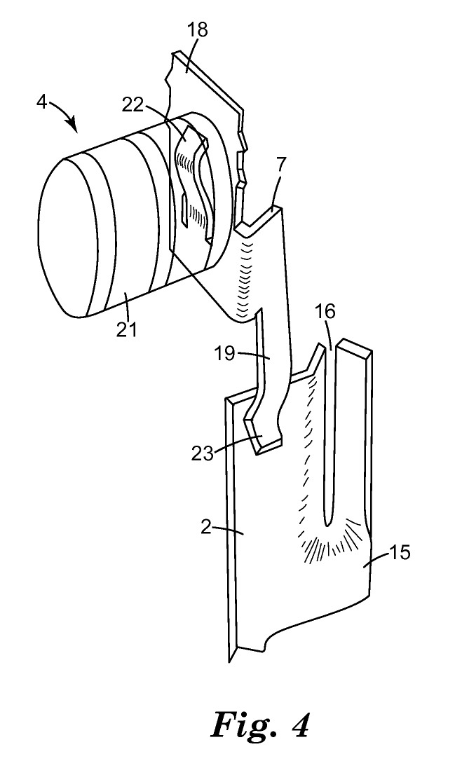

FIG. 4 shows a three dimensional view of a contact element 2 of the termination block 1 with an overvoltage protection device 4. The housing 8 of the termination block 1 and the cap 5 are not shown in the figure. The contact element 2 comprises an IDC element 15 with a slot 16. An electrical conductor connected to the contact element 2 is inserted into the slot 16 of the contact element 2 thereby displacing the insulation from a portion of the electrical conductor and electrically connecting the electrical conductor to the contact element 2. FIG. 4 further shows an exemplary embodiment of how the overvoltage protection device 4 is electrically connected to the contact element 2. For electrically connecting the overvoltage protection device 4 to contact element 2, a protection contact 7 can be used. The protection contact 7 of the embodiment shown in FIG. 4 is stamped out of a sheet metal. It comprises a base plate 18 and a leg 19. The base plate 18 and the leg 19 are arranged generally perpendicular to each other. The base plate 18 extends in a parallel plane to one side of the gas discharge tube 21 of the overvoltage protection module 4. The gas discharge tube 21 of the overvoltage protection module 4 has a cylindrical shape. The base plate 18 comprises a contact zone 22 for making electrical contact between the protection contact 7 and the gas discharge tube 21. The contact zone 22 is a rectangular tap provided by cutting-out or stamping from the base plate 18. It is cut out at three sides and connected at one side to the base plate 18. The contact zone 22 further is bent into the direction of the gas discharge tube 21 for providing a electrical connection. The leg 19 extends from the base plate 18 in the direction of the contact element 2 of the termination block 1. It has a rectangular shape. The leg 19 comprises an angular shaped portion 23 at its end to create a spring contact to connect with the contact element 2. For making the connection reliable the contact zone 22 and the leg 19 contact the gas discharge tube 21 and the contact element 2 each with a certain tension. When two protection contacts 6 and 7 are used for one gas discharge tube 21 and the contact zones of each protection contact 6 and 7 touch the gas discharge tube 21 with a certain tension, the protection contacts 6 and 7 can be used as fixing elements as well, e.g. the gas discharge tube 4 is clamped between the two contacts 6 and 7. Thus, the protection contacts 6 and 7 would fulfill two functions—establishing an electrical connection between the gas discharge tube 21 and the contact elements 2, 3 and fixing the gas discharge tube 21 in the cap 5.

FIG. 5 shows a cross section and partially cut section side view of a termination block 1 with a cap 5 in an open position. FIG. 5 also shows the housing 8 of the termination block 1 with a ground bar 11 at the outside. The ground bar 11 is L-shaped in cross section and surrounds the upper side of the housing 8with its short leg. Within the housing 8 is arranged a contact element 2 with an IDC element (shown in FIG. 6). The housing 8 comprises a receiving space 24. The upper edge of the contact element 2 is located in that receiving space 24 for receiving an electrical conductor 35 (not shown in FIG. 5). The cap 5 is connected with the housing 8 by a swivel axis 25 that is pivot-mounted in a bearing 26 of the housing 8. Swivel axis 25 and bearing 26 may be out of plastic as well as the housing 8 and the cap 5. Such a construction is advantageous because it can be easily manufactured, e.g. by injection moulding. The bearing 26 and the housing 8 of the shown embodiment are each made out of one piece. The swivel axis 25 can be snap fitted into the bearing 26. It is also possible to have a bearing 26 out of a separate part that has to be fixed to the housing 8 of the termination block 1. Any other known hinge may be used as well, such as for example a living hinge.

The cap 5 of the termination block 1 comprises a cap housing 27 with a closing element 28 that includes a leg 29 and a latch 31. The latch 31 cooperates with a not shown catch in the housing 8 of the termination block 1 for securing the cap 5 to the housing 8 in its closed position. Latch 31 and the catch may work together as a snap fit. Therefore, the leg 29 may be made out of a material which is resilient. The cap 5 comprises a wire stuffer 32 at its lower side. The wire stuffer 32 is aligned with the IDC element of the contact element 2. In the partially cut section side view of FIG. 5, two sidewalls 33 and a gap 34 can be seen. For electrically connecting an electrical conductor 35 with the contact element 2, the electrical conductor 35 has to be positioned over the contact element 2 and the cap 5 has to be swivelled from its open position into its closed position. Thereby, the underside of the wire stuffer 32 engages the electrical conductor 35 and pushes it into the IDC element.

FIG. 6 shows the closed position of the cap 5. The latch 31 secures the cap 5 in its closed position. The wire stuffer 32 with two sidewalls 33 is positioned around the contact element 2 in the receiving space 24. The contact element 2 extends into the gap 34 of the wire stuffer 32 when the cap 5 is in its closed position. FIG. 6 also shows the electrical conductor 35 after insertion into the IDC element of the contact element 2. The electrical conductor 35 is coming from outside the housing 8 through a not shown slot in the housing 8 and stays in the receiving space 24 of the housing 8.

The inside of the cap 5 that is shown in FIGS. 5 and 6 will be described in more detail below. In the middle of the cap 5 is arranged the gas discharge tube 21 of the overvoltage protection device 4. A U-shaped grounding contact 9 is arranged around the gas discharge tube 21. The shape of the grounding contact 9 is adapted to the shape of the inside of the cap 5. The grounding contact 9 contacts the gas discharge tube 21 at two sides with its two legs 38. The grounding contact 9 further provides a L-shaped extension 36 that electrically connects to the grounding contact 9. The long leg of the extension 36 extends along the leg 38 of the grounding contact 9. The short leg of the extension 36 extends into a direction away from the swivel axis and into the direction to the opening of the cap 5. In the closed position of the cap 5, the extension 36 of the grounding contact 9 contacts the ground bar 11 of the termination block 8. FIG. 6 also shows the protection contact 7 already described in detail with reference to FIG. 4. The protection contact 7 has a base plate 18 and a leg 19. The base plate 18 connects the contact zone 22 (not shown in FIG. 6) to the gas discharge tube 21 and the leg 19 to the contact element 2. As described with reference to FIG. 4, the protection contacts 6 and 7 can also be used as fixing elements for the gas discharge tube 21 in the cap 5. The same is true for the U-shaped grounding contact 9.

The cap 5 further comprises a handle 37 for opening and closing the cap 5. By pushing the handle 37 into the direction of the arrow C the latch 31 is moved out of the catch in the housing 8 of the termination block 1 and the cap 5 can be swivelled around the swivel axis 25. The handle 37 can also be activated for closing or securing the cap 5 into its closed position.

### REFERENCE NUMBERS

1 termination block
2 contact element
3 contact element
4 overvoltage protection device
5 cap
6 protection contact
7 protection contact
8 housing
9 grounding contact
11 ground bar
12 front side
13 electronic module
14 rear side
15 IDC element
16 slot
18 base plate
19 leg
21 gas discharge tube
22 contact zone
23 angular shaped portion
24 receiving space
25 swivel axis
26 bearing
27 housing
28 closing element
29 leg
31 latch
32 wire stuffer
33 sidewalls
34 gap
35 electrical conductor
36 extension
37 handle
38 leg

1. A termination block comprising
a housing;
contact elements contained within the housing for connecting electrical conductors therewith;
a cap that is pivotally attached to the housing of the termination block and can be swivelled from an open position into a closed position, wherein
the cap comprises a functional module.

2. The termination block according to claim 1, wherein the contact elements comprise IDC elements with slots in which the electrical conductors may be urged.

3. The termination block according to claim 2, wherein the cap comprises means for urging the electrical conductor into the IDC element.

4. The termination block according to claim 1, wherein the functional module is an overvoltage protection device.

5. The termination block according to claim 4, wherein the overvoltage protection device (4) is a two or a three electrode overvoltage protection device.

6. The termination block according to claim 1, wherein the termination block further comprises a grounding element.

7. The termination block according to claim 6, wherein the overvoltage protection device is electrically connected with the grounding element over a grounding contact at least partially integrated in the cap when the cap is in its closed position.

8. The termination block according to claim 5, wherein the overvoltage protection device is electrically connected with the contact elements of the termination block over a protection contact at least partially integrated in the cap when the cap is in its closed position.
